(19) United States
(12) Patent Application Publication
(10) Pub. No.: US 2025/0081072 A1
(43) Pub. Date: Mar. 6, 2025

(54) Communication Coordination and Power Saving Techniques in Non-Terrestrial Networks

(71) Applicant: Apple Inc., Cupertino, CA (US)

(72) Inventors: Pavan Nuggehalli, San Carlos, CA (US); Alexander Sirotkin, Hod Hasharon (IL); Chunxuan Ye, San Diego, CA (US); Fangli Xu, Beijing (CN); Haijing Hu, Los Gatos, CA (US); Naveen Kumar R Palle Venkata, San Diego, CA (US); Ralf Rossbach, Munich (DE); Sarma V Vangala, San Jose, CA (US); Sethuraman Gurumoorthy, San Jose, CA (US); Yuqin Chen, Shenzhen (CN); Zhibin Wu, Los Altos, CA (US)

(21) Appl. No.: 18/724,385

(22) PCT Filed: Jan. 5, 2022
(86) PCT No.: PCT/CN2022/070297

§ 371 Date: Jun. 26, 2024

(51) Int. Cl. H04W 36/32; H04W 36/08; H04W 84/06

(52) U.S. Cl. CPC H04W 36/322; H04W 36/08; H04W 84/06

(57) ABSTRACT

A user equipment (UE) may receive a downlink message from a non-terrestrial network (NTN) which may include one or more sets of terrestrial network (TN) cell reselection information. The one or more sets of TN cell reselection information may further include location information corresponding to one or more cells of the TN. The UE may determine its location and, in response to receiving the downlink message, compare its location to the location information corresponding to the one or more cells of the TN. The UE may then select, based on the comparison, a set of the one or more sets of TN cell reselection information and further perform a cell reselection procedure based on the selection.

### PRIORITY INFORMATION

This application is a national phase entry of PCT application number PCT/CN2022/070297, entitled “Communication Coordination and Power Saving Techniques in Non-Terrestrial Networks,” filed Jan. 5, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for enhancing communication coordination and power saving techniques in non-terrestrial networks.

### DESCRIPTION OF THE RELATED ART

Wireless communication systems are rapidly growing in usage. Wireless devices, particularly wireless user equipment devices (UEs), have become widespread. Additionally, people are becoming increasingly mobile including international travel. Non-terrestrial networks (NTNs) such as 3GPP satellite networks have increased in usage, in particular during international mobility scenarios. Accordingly, increased reliability and connectivity for UEs using NTNs are desirable.

### SUMMARY

Embodiments are presented herein of apparatuses, systems, and methods for enhancing communication coordination and power saving techniques in non-terrestrial networks.

In some embodiments, a user equipment (UE) may receive a downlink message from a non-terrestrial network (NTN). The downlink message may include one or more sets of terrestrial network (TN) cell reselection information. The one or more sets of TN cell reselection information may further include location information corresponding to one or more cells of the TN. The UE may further determine its location and compare it with the location information corresponding to the one or more cells of the TN. The UE may then select, based on the comparison, a set of the one or more sets of TN cell reselection information and further perform a cell reselection procedure based on the selection.

According to some embodiments, the one or more sets of TN cell reselection information may include at least one of a list of frequencies to measure, a whitelist corresponding to one or more TN cells to search, and a blacklist corresponding to one or more TN cells to ignore. Additionally or alternatively, the location information of the one or more cells may include at least one of a list of GNSS coordinates and a corresponding area with shape-specific parameters.

According to further embodiments, the UE may receive, via a non-access stratum (NAS) layer, an indication from the NTN to cease higher priority public land mobility network (PLMN) searches. Additionally or alternatively, the one or more sets of TN cell reselection information may include one or more system information blocks (SIBs) which may further be configured as system information block-4 (SIB4). In some embodiments, the one or more SIBs configured as SIB4 may include one or more geographic tags which are associated with distinct SIBs. Moreover, the distinct SIBs may include cell reselection information for corresponding locations associated with the respective geographic tags of the one or more TN cells.

In some embodiments, the one or more SIBs configured as SIB4 may include one or more tracking area codes (TACs). Additionally or alternatively, the UE may determine, based on TAC specific reference locations of the one or more TACs and the location of the UE, a TAC which corresponds to a location closest to the UE. Furthermore, the UE may select a set of the one or more sets of TN cell reselection information associated with the TAC corresponding to the location closest to the UE, according to some embodiments. Additionally or alternatively, the TAC may correspond to a registration area of the UE but the UE may not be currently registered with that particular TAC(s).

According to some embodiments, the UE may transmit, to a network node of the NTN, radio resource control (RRC) signaling which may include a request message. Additionally or alternatively, the request message may include an indication of a geographic area of interest of the UE.

In some embodiments, a network node configured to operate as part of a non-terrestrial network (NTN) may receive radio resource control (RRC) signaling from a user equipment (UE) which may include a request message that indicates a geographic area of interest of the UE. Additionally or alternatively, the network node may compare, in response to receiving the request message, the geographic area of interest of the UE and one or more respective locations of one or more cells of a terrestrial network (TN). Furthermore, the network node may select, based on the comparison, one or more sets of TN cell reselection information corresponding to the one or more cells of the TN, according to some embodiments. Additionally or alternatively, the network node may transmit a downlink message to the UE, wherein the downlink message may include the one or more sets of TN cell reselection information. In some embodiments, the downlink message may be at least part of one or more system broadcast transmissions and therefore may be available to the requesting UE as well as any other UEs capable of receiving the system broadcast signaling.

According to some embodiments, the request message may include at least one of fine and coarse global navigation satellite system (GNSS) coordinates. Additionally or alternatively, the one or more sets of cell reselection information may include at least one of a list of frequencies for the UE to measure, a whitelist corresponding to one or more TN cells to search, and a blacklist corresponding to one or more TN cells to ignore. In some embodiments, the one or more sets of TN cell reselection information may be included in one or more system information blocks (SIBs). Additionally or alternative, the network node may indicate, through one or more SIBs configured as system information block-4 (SIB4), which of the one or more SIBs are being transmitted.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 is a network infrastructure diagram illustrating a 3GPP satellite network deployment, according to some embodiments;

FIGS. 6A and 6B are schematic diagrams illustrating interworking between 3GPP terrestrial and satellite (e.g., non-terrestrial) radio access networks (RANs), according to some embodiments; and

FIG. 7 is a flowchart diagram illustrating a method for enhanced cell reselection for non-terrestrial networks, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
GSM: Global System for Mobile Communication
UMTS: Universal Mobile Telecommunication System
EUTRA: Evolved UMTS Terrestrial Radio Access
LTE: Long Term Evolution
NR: New Radio
TX: Transmission/Transmit
RX: Reception/Receive
RAT: Radio Access Technology
RRC: Radio Resource Control
NTN: Non-Terrestrial Network
TN: Terrestrial Network
SIB: System Information Block
SIB4: System Information Block-4
LEO: Low Earth Orbit
GEO: Geosynchronous Earth Orbit
UAV: Unmanned Aerial Vehicle
NAS: Non-Access Stratum
PLMN: Public Land Mobility Network
TAC: Tracking Area Code
GNSS: Global Navigation Satellite System

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

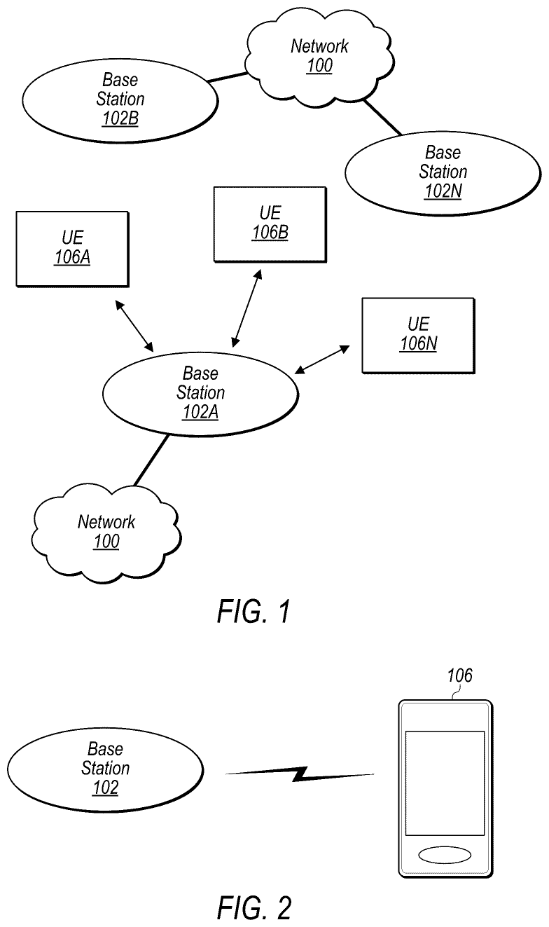

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for enhancing timing relationships in non-terrestrial networks (NTNs), such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

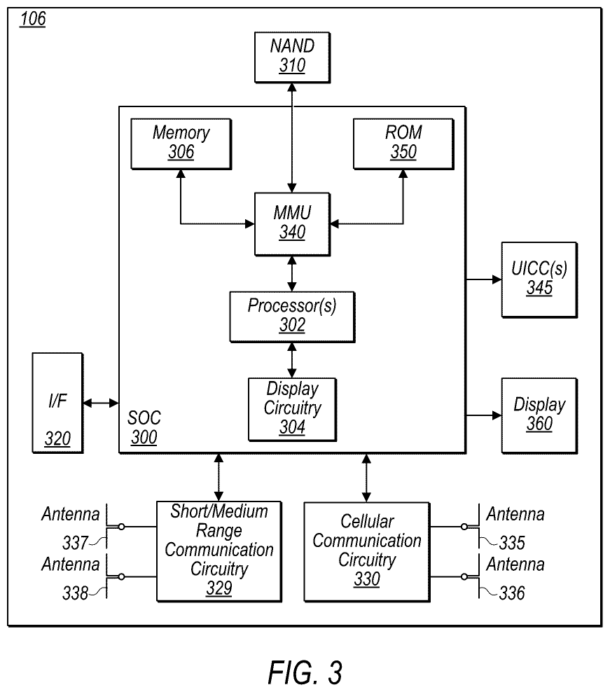

### FIG. 3—Block Diagram of a UE Device

FIG. 3 illustrates a block diagram of an example UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. In some implementations, the display 360 may include a touchscreen capable of detecting user input, e.g., as touch events. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector interface (I/F) 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing methods for the UE 106 to enhance communication coordination and power saving techniques in NTNs, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to enhance communication coordination and power saving techniques in NTNs according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 (e.g., cellular communication circuitry) may include a Wi-Fi controller, a cellular controller (e.g., LTE, LTE-A, and/or NR controller), and BLUETOOTH™ controller, and in at least some embodiments, one or more or all of these controllers may be implemented as respective integrated circuits (ICs or chips, for short) in communication with each other and with SOC 300 (and more specifically with processor(s) 302). According to some embodiments, radio 330 may be utilized to communicate with one or more NTNs. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

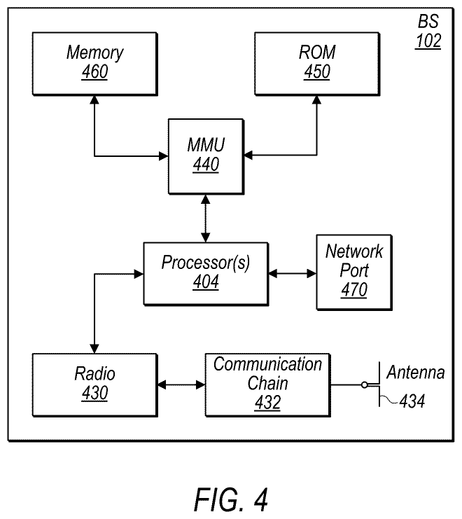

FIG. 4—Block Diagram of a Base Station

FIG. 4 illustrates a block diagram of an example base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE device 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g., it may include at least one Ethernet port, and radio 430 may be designed to communicate according to the Wi-Fi standard.

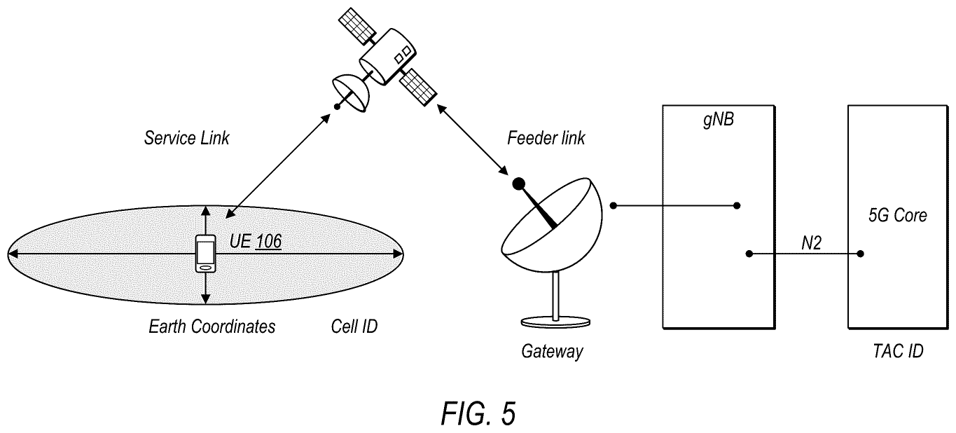

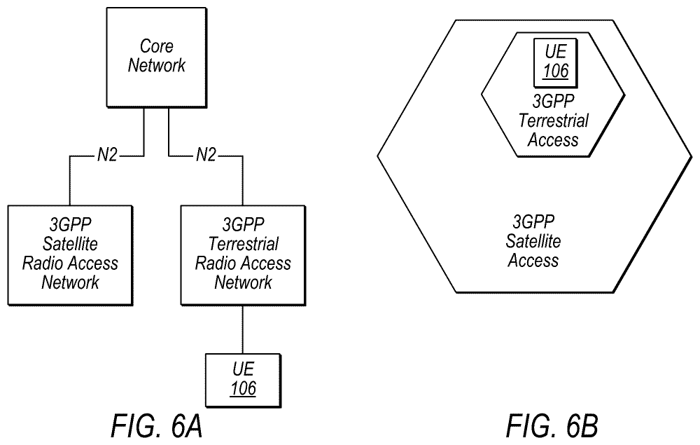

FIGS. 5-6—3GPP Satellite Network Infrastructure

FIG. 5 is a network infrastructure diagram illustrating a 3GPP satellite network deployment, according to some embodiments. As illustrated, a satellite broadcasts a service link to a UE, such as UE 106, where the UE is operating within a cell (e.g., of a NTN). The satellite also conducts communications with a terrestrial gateway via a feeder link, and the gateway is in turn communicatively coupled to a base station (e.g., a gNB). In some embodiments, the base station may be implemented as a combination of a NTN payload and a NTN gateway.

According to some embodiments, a network node of the NTN may be in the form of a satellite in communication with a UE. For example, as shown in FIG. 5, UE 106 may be configured to communicate directly with the NTN instead of or in addition to communicating with the terrestrial network of the gNB. Accordingly, the network node (e.g., satellite) may provide NTN configuration information to the UE similar to that of a base station providing TN configuration information.

FIGS. 6A and 6B illustrate interworking between 3GPP terrestrial and satellite (e.g., non-terrestrial) radio access networks (RANs), according to some embodiments. As illustrated, in FIG. 6A, a UE 106 communicates with a 3GPP terrestrial RAN, e.g., through a gNB as shown in FIGS. 1-2. The 3GPP terrestrial RAN is coupled via an N2 interface with a core network, and a 3GPP satellite RAN is also coupled to the core network via the N2 interface. FIG. 6B illustrates a UE 106 operating with a cell to obtain 3GPP terrestrial access. The UE 106 also operates within a broader geographic range that provides 3GPP satellite access. It will be appreciated that a UE may communicate directly with the NTN RAN, e.g., instead of or in addition to communicating with the terrestrial RAN.

According to some embodiments, a NTN cell may not be directly associated with (e.g., is distinct from) a PLMN available to the UE (e.g., via the TN). However, in some embodiments, a cell of the NTN may overlap a geographic area that includes cells of a PLMN (e.g., corresponding to the TN). Accordingly, the NTN may be configured to provide location information (which may pertain to a geographic area corresponding to a PLMN of the TN) useable by the UE for purposes of cell reselection. In some embodiments, the UE may be connected to the NTN and upon receiving cell reselection information, may perform a cell reselection procedure to connect to the TN which may be prioritized over the NTN.

### NTN-TN Idle Mode Mobility

As diverse network technologies are integrated with more traditional cellular network technologies, new network characteristics may arise. As one example, introducing new classes of cellular base stations or repeater stations may introduce propagation delays that are noticeably greater, and noticeably more variable, than those associated with more traditional base stations.

For example, 3GPP has recently expanded to define non-terrestrial networks (NTN) within the 3GPP ecosystem. In such systems, propagation delays between a UE, such as the UE 106, and a non-terrestrial network may be far greater than propagation delays between the UE and a traditional terrestrial base station, because a satellite may be far from the terrestrial UE, relative to distances experienced in terrestrial networks. Additionally, such systems may include cells covering larger geographic areas than traditional cells, which may lead to a large differential in propagation delays at two points within a cell (e.g., of the NTN). In other words, in such systems, a UE located at a first point in a cell may experience a significantly greater propagation delay than a UE located at a second point in the same cell.

Due to increased cellular network demand in atypical or remote locations, it is expected that operators may offer, by themselves or via roaming agreements, cellular service in both NTN and terrestrial network (TN) systems. According to some embodiments, NTNs and TNs may operate in different frequency bands (e.g., frequency range 1 (FR1) and frequency range 2 (FR2). Additionally, as TN and NTN frequency bands may be distinct, UEs may prioritize the associated TN frequency bands over NTN frequency bands. Accordingly, appropriate network implementation for configuration of cell reselection frequency priority and/or white/black-cell lists may be necessary.

As UEs tend to spend most of their power in idle mode performing operations searching for frequencies and/or cells for reselection, network enhancements for inter-frequency cell reselection in radio resource control (RRC) idle mode for UEs may help the UEs save power by providing certain configuration information to the UE. According to some embodiments, the network may provide a list of frequencies to measure (with or without priorities), a “whitelist” of neighboring cells to search, and/or a “blacklist” of cells to ignore. For example, while a whitelist may include a list of cells (and/or cell identifier parameters), a blacklist may include a list of cells and/or cell identifiers that the UE should disregard in its cell reselection procedures. In other words, a blacklist provided by the network may inform the UE or provide an indication of cells which should be avoided or not included in subsequent cell reselection procedures or related measurements.

Moreover, as NR has developed, NR NTN cells have been designed to cover large areas and accordingly the associated NTN may have hundreds of neighboring TN cells. For example, as discussed in 3GPP TR 38.821, scenario parameters describe the max beam footprint size for geosynchronous Earth orbit (GEO) and low Earth orbit (LEO) satellites to be on the order of 3500 km and 1000 km, respectively. For example, the max beam footprint size may correspond to a cell length of an elliptical beam footprint. In other words, the max beam footprint size may be equivalent to twice the major axis of the ellipse corresponding to the beam footprint Thus, one NTN cell may neighbor (and/or overlap with) many TN cells. It may not be practical and/or useful for the network to send such a large lists of frequencies and/or neighbor TN cells as this amount of information may overburden the UE by forcing it to parse through these large amounts of data for relevant and/or useful frequencies, whitelists, and/or blacklists. Accordingly, it may be beneficial from both the network and UE perspectives to implement an efficient delivery of reselection information.

As one option to improve efficiency for cell reselection for NTN and TN systems, one approach may be directed toward geographic based cell reselection. For example, a majority of NTN UEs may be geographically aware of their physical location due to being equipped with global navigation satellite system (GNSS) hardware and/or software. Additionally or alternatively, the UEs may also be aware of which tracking area(s) (TAs) are illuminated by the satellite payload. For example, the UE may be aware of which TAs (corresponding to cells of the TN) may be partially or fully encompassed by the NTN cell. In other words, the UE may be aware of which TN cells (and corresponding tracking area codes) are within the boundaries of the NTN cell. Accordingly, by indicating location specific cell reselection information to the UE (based on the UEs physical location) the network may be able to assist the UE in avoiding unnecessary searches and increasing efficiency by providing frequencies and cells that the UE is likely to find or use based on the UE's location. Additionally or alternatively, the network may be able to reduce its broadcast burden by being aware of certain UE locations. For example, if the network determines that there are no NTN UEs in certain areas, it may reduce its transmissions based on this information in an effort to conserve power.

Moreover, NTN systems are likely to be used in areas where there are no TN cells present. For example, UEs may utilize NTN systems when in inaccessible terrains such as mountains, forests or in maritime environments (e.g., cruise ships, cargo ships, oil tankers). Therefore, UEs in these scenarios or environments should ideally not be searching for TN cells in these areas so as to provide some measure of power conservation. Accordingly, GNSS based enhancements may be applicable in preventing unnecessary cell search for UEs in conditions such as these.

### GNSS and SIB Based Enhancements

In some embodiments, the network (e.g., NTN satellite) may broadcast geographic locations in which the UE should not search for neighboring TN cells. For example, the network may indicate a list of GNSS coordinates and a corresponding area and/or shape (circular, rectangular, polygon, elliptical, etc.) with shape-specific parameters (e.g., diameter, radius, perimeter, area, major axis length, etc.). According to some embodiments, the GNSS coordinates and/or additional information provided by the network may be included in additional fields in a system information block (SIB) such as SIB4 or a newly implemented SIB. Additionally or alternatively, if there is little to no possibility of finding a higher priority TN cell in the geographic area indicated, further non-access stratum (NAS) layer enhancements may be able to indicate to the UE to stop higher priority public land mobility network (PLMN) searches. For example, higher priority PLMN searches may involve the UE periodically searching for higher priority PLMNs as part of a NAS PLMN selection procedure. Accordingly, if no TN cells are available, the UE may utilize NTN cells. Additionally or alternatively, this NAS indication may be based on a location of the UE. For example, this NAS based indication may be beneficial for UEs in geographically isolated environments (e.g., in the middle of the ocean) to refrain from searching for TN cells which are likely not to be present in said environments. Thus, further power or resource conservation may be realized. According to some embodiments, an operator may allocate a higher priority to an NTN frequency over a TN frequency.

In some embodiments, GNSS based cell reselection enhancements may be implemented through further enhancements to SIB4 (e.g., as may be transmitted by a NTN satellite). For example, SIB4 may be enhanced to provide geographic tags, via the network, to the UE. Accordingly, the UE may select the cell reselection information corresponding to the tag that is nearest to the UE's location. However, sending multiple sets of cell reselection information tagged by the appropriate geographic location may not always be feasible. For example, due to specifications regarding system information (SI) size, the SIB4 size may be limited to a maximum size of approximately 2976 bits. Therefore, including non-relevant or non-useful cell reselection information (e.g., system information pertaining to neighbor TN cells not in the UE's vicinity) should be minimized.

In some embodiments, the SIB size limitation may be addressed based on enhancements involving tracking area codes (TACs). Accordingly, the SIB4 may be enhanced to provide TAC specific reference locations and/or TAC specific cell reselection information. Moreover, the TN neighbor cell list may be different for each TAC as the TAC specific reference location may refer to a particular point on Earth (e.g., ground). Accordingly, the UE may be able to, by comparing its location with the TAC specific reference location, determine which TAC is closest to the UE's geographic location. In some embodiments, the selected TAC may not be the TAC that the UE is currently registered with but belongs to the UE's registration area. For example, a registration area may correspond to a set of TACs. Moreover, the UE may have previously sent a registration update to a base station (e.g, gNB) which may be part of a particular TAC. Subsequently, it may be served by a different gNB that belongs to a different TAC. Accordingly, if the new TAC also belongs to the UE's registration area, the UE may not be required to send a new registration update and the UE may then select the cell reselection information associated with the selected TAC. Moreover, this approach may be practical since the number of TACs may be limited to 12 but is typically less (e.g., 2) in practice. In other words, the maximum number of TACs that a base station (e.g., gNB) may be capable of broadcasting may be limited to 12 TACs. According to some embodiments, a TAC may correspond to a set of gNBs rather than geographic coordinates.

However, although practical, the TAC based approach may have some limitations. For example, the number of cell reselection information copies that can be carried in SIB4 may be limited (e.g., due to size limitations as discussed above). Moreover, a single TAC area may include hundreds of TN cells, so the problem remains (even if the severity is somewhat reduced). Accordingly, further enhancements to SIB4 based on GNSS coordinates may provide increased efficiency with regard to cell reselection in NTN and TN systems. In some embodiments, SIB4 may be enhanced to provide geographic tags in which each tag may be associated with a distinct SIB that contains cell reselection information for that location. Additionally or alternatively, each enhanced SIB may be able to carry or include multiple copies of cell reselection information. Moreover, NTN satellites may transmit multiple Tracking Area Codes (TACs) in which each TAC may correspond to a fixed geographic area. For example, a TAC may include or correspond to shape-specific parameters (e.g., diameter, radius, perimeter, area, major axis length, etc.) corresponding to the fixed geographic area.

In some scenarios, there may be geographic areas where there are very few or no NTN capable UEs (e.g., or no/few UEs in communication with the NTN). Accordingly, there may not exist a need for the NTN satellite to transmit the new or enhanced SIBs as described above. As one alternative, the new and/or enhanced SIBs (e.g., SIB4 extensions) may be made in an “on-demand” fashion. In some embodiments, the SIB4 enhancements may be made in response to a particular SIB request from a UE. For example, certain UEs that need a particular SIB may transmit a request to the network asking for said particular SIB. This may allow for increased network efficiency by saving the network from transmitting all of the SIB4 extensions all the time.

In some embodiments, the number of such new SIBs may be quite large. Accordingly, instead of requesting the network for a particular SIB, the UE may be configured to indicate which geographic area it is interested in by providing its GNSS coordinates (fine or coarse).

Additionally or alternatively, it may be further beneficial to use RRC messaging for requesting system information based on UE location to better ensure user privacy. According to some embodiments, the NTN satellite may indicate (e.g., in SIB4) which SIBs are actually being transmitted.

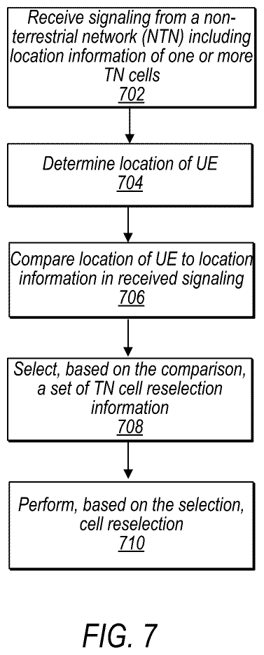

### FIG. 7—Enhanced Cell Reselection Methods for Non-Terrestrial Networks

FIG. 7 is a flowchart diagram illustrating an example method for enhanced cell reselection for non-terrestrial networks, according to some embodiments. Aspects of the method of FIG. 7 may be implemented by a wireless device, such as the UE(s) 106, in communication with a network, e.g., via one or more base stations (e.g., BS 102) as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) of the UE (e.g., processor(s) 302, baseband processor(s), processor(s) associated with communication circuitry, etc., among various possibilities) may cause the UE to perform some or all of the illustrated method elements. Similarly, one or more processors (or processing elements) of the BS (e.g., processor(s) 404, baseband processor(s), processor(s) associated with communication circuitry, etc., among various possibilities) may cause the UE to perform some or all of the illustrated method elements. In some embodiments, the UE may communicate directly with a base station, and the base station may in turn communicate with an access mobility function (AMF) of a 5GC that services the PLMN associated with the TN. Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

At 702, the UE may receive a downlink message from a non-terrestrial network (NTN). In some embodiments, the downlink message may include one or more sets of TN cell reselection information and location information corresponding to one or more cells of the TN. Additionally or alternatively, the one or more sets of TN cell reselection information may include at least one of a list of frequencies to measure, a whitelist corresponding to one or more TN cells to search, and/or a blacklist corresponding to one or more TN cells to ignore. Additionally or alternatively, the location information of the one or more TN cells may include at least one of a list of GNSS coordinates and a corresponding area with shape-specific parameters. In some embodiments, the downlink message may include one or more geographic tags corresponding to a location and/or shape of the one or more TN cells. In some embodiments, the downlink message may be at least part of one or more system broadcast transmissions and therefore may be available to the requesting UE as well as any other UEs capable of receiving the system broadcast signaling.

At 704, the UE may determine its location. In some embodiments, the determination may be performed at least in part in response to receiving the downlink message from the NTN. For example, upon receiving information regarding potential neighboring cells corresponding to the TN, it may be beneficial for the UE to determine its current location in order to better prioritize the cell reselection and location information sets. Accordingly, the UE may utilize its GNSS hardware and/or software to determine its physical location (e.g., using GPS, GNSS, context from a serving base station, or other methods).

At 706, the UE may compare the location information corresponding to the one or more cells of the NTN to its determined location. For example, it may be beneficial for the UE to determine and/or prioritize the location information of the TN cells based on the UE's location relative to said TN cells. In some embodiments, the UE may compare the location information to one or more geographic tags included in the downlink message.

At 708, the UE may select, based on the comparison, a set of the one or more sets of cell reselection information. For example, it may be beneficial for the UE to utilize the physically closest cell for purposes of signal strength. Accordingly, the UE would likely not seek to utilize cell reselection information corresponding to cells that are separated from the UE by large physical distances as the signal strength would likely be greatly reduced. In other words, the UE may select cell reselection information corresponding to the closest neighboring cell since it would likely have the highest signal strength. Additionally or alternatively, the UE may select cell reselection information based on a comparison of its location and one or more received geographic tags.

At 710, the UE may perform a reselection procedure to a cell of the TN network corresponding to the selected cell information, according to some embodiments. For example, having selected a set of cell reselection information at 708 based on the comparison at 706 of received location information of 702 and the determined UE location of 704, the UE may connect to a TN cell corresponding to the selected set of cell reselection information. In some embodiments, the UE may be connected to the NTN and upon receiving cell reselection information, may perform a cell reselection procedure to connect to the TN which may be prioritized over the NTN. According to some embodiments, having selected cell reselection information corresponding to one or more received geographic tags, the UE may perform search related operations corresponding to at least one of the TN cells and/or one or more received geographic tags.

It should be appreciated that, in various embodiments, some of the elements of the method shown may be performed concurrently, in a different order than shown, may be substituted for by other method elements, or may be omitted, and/or additional method elements may be performed as desired.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

In some embodiments, a device includes: an antenna; a radio coupled to the antenna; and a processing element coupled to the radio. The device may be configured to implement any of the method embodiments described above.

In some embodiments, a memory medium may store program instructions that, when executed, cause a device to implement any of the method embodiments described above.

In some embodiments, an apparatus includes: at least one processor (e.g., in communication with a memory), that is configured to implement any of the method embodiments described above.

In some embodiments, a method includes any action or combination of actions as substantially described herein in the Detailed Description and claims.

In some embodiments, a method is performed as substantially described herein with reference to each or any combination of the Figures contained herein, with reference to each or any combination of paragraphs in the Detailed Description, with reference to each or any combination of Figures and/or Detailed Description, or with reference to each or any combination of the claims.

In some embodiments, a wireless device is configured to perform any action or combination of actions as substantially described herein in the Detailed Description, Figures, and/or claims.

In some embodiments, a wireless device includes any component or combination of components as described herein in the Detailed Description and/or Figures as included in a wireless device.

In some embodiments, a non-volatile computer-readable medium may store instructions that, when executed, cause the performance of any action or combination of actions as substantially described herein in the Detailed Description and/or Figures.

In some embodiments, an integrated circuit is configured to perform any action or combination of actions as substantially described herein in the Detailed Description and/or Figures.

In some embodiments, a mobile station is configured to perform any action or combination of actions as substantially described herein in the Detailed Description and/or Figures.

In some embodiments, a mobile station includes any component or combination of components as described herein in the Detailed Description and/or Figures as included in a mobile station.

In some embodiments, a mobile device is configured to perform any action or combination of actions as substantially described herein in the Detailed Description and/or Figures.

In some embodiments, a mobile device includes any component or combination of components as described herein in the Detailed Description and/or Figures as included in a mobile device.

In some embodiments, a network node is configured to perform any action or combination of actions as substantially described herein in the Detailed Description and/or Figures.

In some embodiments, a network node includes any component or combination of components as described herein in the Detailed Description and/or Figures as included in a mobile device.

In some embodiments, a base station is configured to perform any action or combination of actions as substantially described herein in the Detailed Description and/or Figures.

In some embodiments, a base station includes any component or combination of components as described herein in the Detailed Description and/or Figures as included in a mobile device.

In some embodiments, a 5G NR network node or base station is configured to perform any action or combination of actions as substantially described herein in the Detailed Description and/or Figures.

In some embodiments, a 5G NR network node or base station includes any component or combination of components as described herein in the Detailed Description and/or Figures as included in a mobile device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1-20. (canceled)

21. A method, comprising:
receiving, from a non-terrestrial network (NTN), broadcast information to indicate geographic locations in which searching for neighboring terrestrial network (TN) cells is not required; and
performing, based at least in part the geographic locations, a cell reselection procedure in an IDLE mode or an Inactive mode.

22. The method of claim 21, wherein the broadcast information is received from an NTN satellite.

23. The method of claim 21, wherein the broadcast information further comprises an indication of a list of global navigation satellite system (GNSS) coordinates and a corresponding area associated with the geographic locations.

24. The method of claim 21, further comprising:
receiving, from the NTN, one or more sets of cell reselection information comprised in one or more system information blocks (SIBs).

25. The method of claim 24, wherein the one or more sets of cell reselection information comprise at least a list of frequencies.

26. The method of claim 24, further comprising:
determining a current location;
selecting cell reselection information from the one or more sets of cell selection based on a first geographic location and the current location, wherein the first geographic location corresponds to a geographic tag included in the broadcast information.

27. The method of claim 26, wherein the geographic tag is provided in system information block-4 (SIB4) signaling.

28. A method, comprising:
by a network node configured to operate as part of a non-terrestrial network (NTN):
transmitting, to one or more user equipment (UE) devices, broadcast information from a non-terrestrial network (NTN) to indicate geographic locations in which searching for neighboring terrestrial network (TN) cells is not required by the one or more UEs in an IDLE or Inactive mode.

29. The method of claim 28, wherein the network node is an NTN satellite.

30. The method of claim 28, wherein the broadcast information further comprises an indication of a list of global navigation satellite system (GNSS) coordinates and a corresponding area associated with the geographic locations.

31. The method of claim 8, further comprising:
transmitting, to the one or more UE devices, one or more sets of cell reselection information comprised in one or more system information blocks (SIBs).

32. The method of claim 31, wherein the one or more sets of cell reselection information comprise at least a list of frequencies.

33. The method of claim 31, further comprising:
providing, to the one or more UE devices and in system information block-4 (SIB4) signaling, one or more geographic tags corresponding to the one or more sets of cell reselection information in the broadcast information.

34. An apparatus, comprising:
a processor configured to, when executing instructions stored in a memory, perform operations comprising:
receiving, from a non-terrestrial network (NTN), broadcast information to indicate geographic locations in which searching for neighboring terrestrial network (TN) cells is not required; and
performing, based at least in part the geographic locations, a cell reselection procedure in an IDLE mode or an Inactive mode.

35. The apparatus of claim 34, wherein the broadcast information is received from an NTN satellite.

36. The apparatus of claim 34, wherein the broadcast information further comprises an indication of a list of global navigation satellite system (GNSS) coordinates and a corresponding area associated with the geographic locations.

37. The apparatus of claim 34, wherein the operations further comprise:
receiving, from the NTN, one or more sets of cell reselection information comprised in one or more system information blocks (SIBs).

38. The apparatus of claim 37, wherein the one or more sets of cell reselection information comprise at least a list of frequencies.

39. The apparatus of claim 37, wherein the operations further comprise:
determining a current location;
selecting cell reselection information from the one or more sets of cell selection based on a first geographic location and the current location, wherein the first geographic location corresponds to a geographic tag included in the broadcast information.

40. The apparatus of claim 39, wherein the geographic tag is provided in system information block-4 (SIB4) signaling.
